(19) United States
(12) Patent Application Publication
(10) Pub. No.: US 2023/0052884 A1
(43) Pub. Date: Feb. 16, 2023

(54) Unlockable Tie Apparatus

(71) Applicant: KML Holding Group LLC, Quakertown, PA (US)

(72) Inventor: George R. McDowell, III, Hellertown, PA (US)

(21) Appl. No.: 17/887,253

(22) Filed: Aug. 12, 2022

Related U.S. Application Data
(60) Provisional application No. 63/232,431, filed on Aug. 12, 2021.

(51) Int. Cl. B65D 63/10; B65B 13/02

(52) U.S. Cl. CPC B65D 63/1072; B65B 13/02

(57) ABSTRACT

A tie to secure items therewithin that can be loosened or released to allow the items to be removed therefrom and the tie to be reused. The tie includes an elongated strap having teeth formed thereon that engage with teeth in a latch extending into an opening in a locking head that the strap passes through. The engagement of the strap teeth and the latch teeth allow movement in only one direction (tightening). A receptacle is located on the latch that enables a tool to be received therein and pivot the latch in order disengage the latch teeth from the strap teeth so that the strap can move in an opposite direction (removal).

### BACKGROUND

Ties are used to tie, fasten and/or connect various items. For example, ties may be used to secure a cable (e.g., power cord) that is wrapped in a bundle for storage together in the bundle. Ties may be used to secure different cables (e.g., power cords, data cables, other cables) that are traversing a similar path together for organization. Ties may be used to secure different cables to other objects, such as to a desk, chassis or the like they are being utilized in. Ties, often known as zip ties, are designed for easy application. The zip ties may include an elongated body with teeth and a head through which the body may traverse in a single direction associated with tightening the tie. The zip tie may be placed around the cables to be secured together or around the cables and object that the cables are to be secured to and then may be tightened by placing the body through the head until the desired tightness is achieved. Typical zip ties cannot be loosened or removed and are thus designed for a single use.

Accordingly, to remove or loosen a zip tie it must be cut. Zip ties may need to be removed or loosened for various reasons including, for example, removing a cable from a bundle of cables, rerouting one or more cables secured therein, or adding a cable to the bundle of cables. If the cables are still to be bundled and/or held in place a new zip tie must then be utilized. The process of cutting and removing existing ties is not only inconvenient and costly but may lead to damage to the cables or the item to which the cables are secured. Damaging, for example, a motorcycle that a cable was secured to may diminish the aesthetic of the motorcycle and possibly the value thereof. Damaging one or more cables in a wire harness (bundle of cables) may require the whole wire harness to be replaced. The replacement of a wire harnesses is a problem for large production jobs, such as large airliners, as the airlines may include miles and miles of electrical cables that need to be replaced, rerouted and resecured.

Releasable cable ties have been proposed but they are often awkward to utilize. Furthermore, the releasable ties may require a large head that may not be desirable in certain situations. Moreover, the releasable ties enable anyone the ability to release the tie which may not be desirable. What is needed is a tie that is secured but can be unlocked and adjusted or removed that is not awkward to use, does not require a large head, and cannot easily be released by anyone.

### BRIEF DESCRIPTION OF THE DRAWINGS

The structure, objects, and advantages of the releasable cable tie will be understood by referring to the detailed description of illustrative embodiments in conjunction with the accompanying technical drawings, in which:

FIGS. 1A-B illustrate top views of an example unlockable tie, according to one embodiment.

FIGS. 2A-B illustrate cross sectional side views of an example unlockable cable tie, according to one embodiment.

FIG. 3 illustrates a bottom view of an example unlockable cable, according to one embodiment.

FIG. 4 illustrates a cross-sectional side view of an example unlockable cable tie in locked position, according to one embodiment.

FIG. 5 illustrates a perspective view of an example tool that can be utilized to unlock an unlockable cable tie, according to one embodiment.

FIGS. 6A-D illustrates top and side views of an example tool that can be utilized to unlock an unlockable cable tie, according to one embodiment.

FIG. 7 illustrates a cross-sectional side view of an example tool being utilized to unlock an example unlockable tie, according to one embodiment.

FIGS. 8A-D illustrate top views of various configurations of the receptacle(s) that could be formed in the latch, according to various embodiments.

FIGS. 9A-I illustrate various shapes that could be utilized for the receptacles on the latch, according to various embodiments.

FIGS. 10A-C illustrate bottom views of several embodiments of example unlockable ties having a friction bottom surface, according to one embodiment.

FIG. 11 illustrates a top view of an example unlockable tie having an unlockable locking head capable of supporting larger loads, according to one embodiment.

FIG. 12 illustrates a cross sectional side view of an example unlockable tie having an unlockable locking head capable of supporting larger loads, according to one embodiment.

FIG. 13 illustrates a cross sectional side view of a strap of an example unlockable tie being looped back and tucked in an opening in the locking head, according to one embodiment.

FIGS. 14A-F illustrate top views of example unlockable tie with connection mechanisms added thereto, according to one embodiment.

FIG. 15 illustrates a cross sectional side view of an example unlockable tie showing engagement of a strap and locking head, according to one embodiment.

FIG. 16 illustrates a cross-sectional side view of an example tool being utilized to unlock an example unlockable tie, according to one embodiment.

FIG. 17 illustrates a cross sectional side view of an example tie showing engagement of a strap and locking head, according to one embodiment.

FIG. 18 illustrates a cross-sectional side view of an example tool being utilized to unlock an example unlockable tie, according to one embodiment.

FIGS. 19A-C illustrate top/side views of example unlockable ties having a pass through formed in the strap that enables the tie to be secured to an object before the tie is used, according to one embodiment.

### DETAILED DESCRIPTION

A zip tie to secure one or more items (e.g., cables) therewithin and/or to an object (e.g., desk, chassis) that can be unlocked so that it may be loosened or removed to allow the items to be adjusted and/or removed or add other items thereto. The zip tie includes an elongated strap having teeth formed thereon that engage with teeth in a locking head to allow movement in only one direction (tightening). The locking head also includes a releasing mechanism that enables the teeth in the locking head to be disengaged from the teeth on the elongated strap so that the strap can move in an opposite direction that enables loosening of the strap or removal of the strap. The releasing mechanism may be configured to face away from the items secured within the strap to provide more room for engagement. The releasing mechanism may require a tool to engage therewith so that the strap cannot be released accidently or by undesirable individuals (e.g., those without the tool).

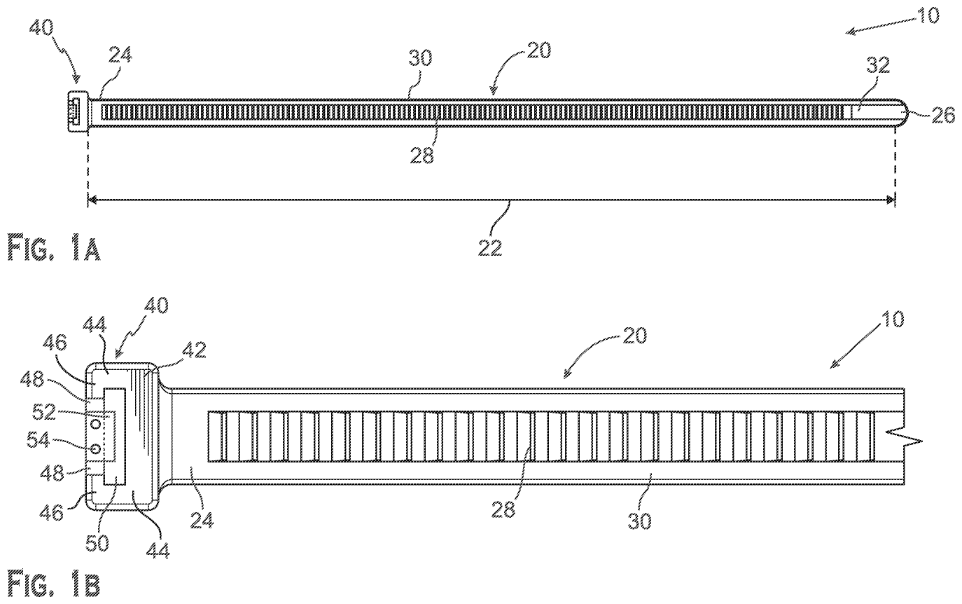

FIG. 1A illustrates a top view and FIG. 1B illustrates a close-up top view of an example tie 10 that can be unlocked (an unlockable tie) in order to be removed without requiring the tie to be cut or broken. The tie 10 includes an elongated planar strap 20 and an unlockable locking head 40. The strap 20 has an elongated length 22 that traverses from a first end 24 (left as illustrated) to a second end 26 (left as illustrated). The length 22 may vary depending on what the tie 10 is to be used for. A first side (top as illustrated) of the strap 20 includes a plurality of teeth 28 formed within guide rails 30. The strap teeth 28 may be saw tooth shaped where on side is flat and the other side is angled (but are not limited thereto). The first end 24 is connected to the unlockable locking head 40. The second end 26 of the of strap 20 includes a tongue 32 (with no teeth). The tongue 32 and the guiderails 30 assist in guiding the strap 20 into the unlockable locking head 40. The inclusion of the tongue 32 on the strap requires a minimum amount of the strap 20 to pass through the locking head 40 before the teeth 28 can secure the strap 20 therein (prevent the strap 20 from being removed from the locking head 40).

The unlockable locking head 40 is wider than the strap 20 and includes a front wall 42 abutting the strap 20, two sidewalls 44 extending perpendicularly from the front wall 42 and two partial back walls 46 extending inward from the sidewalls 44 but providing an open portion 48 therebetween. An opening 50 is formed within the locking head 40 to enable the strap 20 to pass therethrough. The strap 20 passes through the opening 50 from a first side (e.g., bottom) to a second side (e.g., top). When the strap 20 is located within the opening 50, the locking teeth 28 will point toward the two partial back walls 46 and open portion 48. The two partial back walls 46 abut the opening 50 and are utilized to receive the guiderails 30 of the strap 20 and hold the strap 20 within the opening 50. A latch 52 is formed centrally located within the open portion 48 and extends into the opening 50. The latch 52 includes one or more teeth (not separately identified in FIGS. 1A-B) that extend into the opening 50 to engage with the strap teeth 28. The engagement of the one or more latch teeth and the strap teeth 28 within the opening 50 enable the strap 20 to pass through the opening 44 in a first direction (tightening) but not in a second direction (loosening, removing).

The latch 52 includes one or more receptacles 54 (two illustrated) formed therein. The receptacle(s) 54 are to receive a tool in order to engage the latch 52 and pivot the latch 52 out of the opening 50. The engaging and pivoting of the latch 52 causes the latch teeth to be moved away from the opening 50 so as to disengage with the strap teeth 28. When the latch teeth and the strap teeth 28 are disengaged, the strap 20 is unlocked and can traverse the opening 50 in the second direction (to loosen or remove). The receptacles 54 are illustrated as simply two side by side holes which would enable a tool having aligned pins (or possibly a paper clip, staple or wire) to be utilized. The receptacle(s) 54 are in no means limited to two aligned holes as illustrated. Rather, the receptacles can be any configuration that enables a tool to be received therein. For example, the receptacle(s) 54 could be a slit capable of receiving, for example, a flat head screwdriver; a cross capable of receiving a Phillips head screwdriver, or a unique design requiring a unique tool to be utilized. According to one embodiment, the receptacle(s) 54 and tool utilized therewith would be something fairly standard to avoid a case where the tool was lost and the tie 10 could not be unlocked.

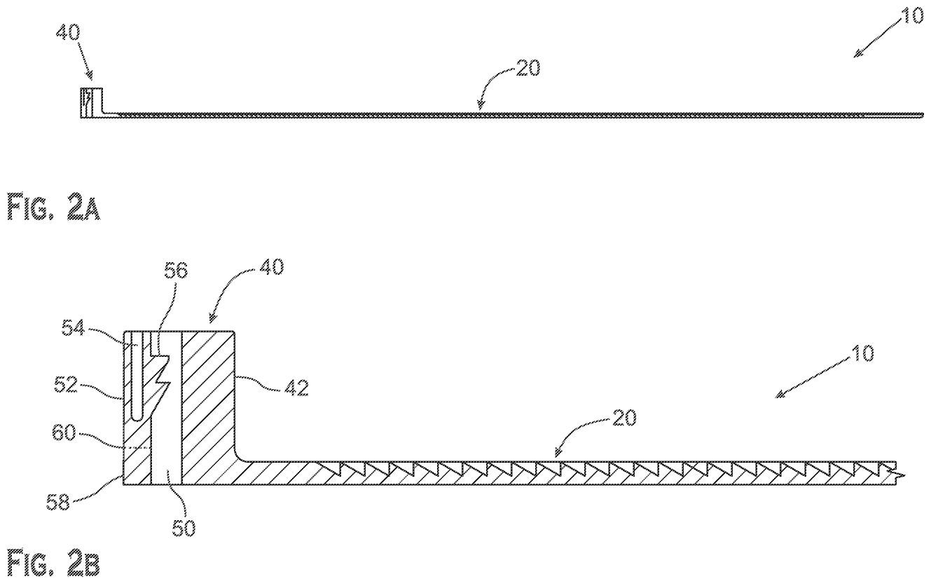

FIG. 2A illustrates a cross-sectional side view and FIG. 2B illustrates a close-up cross-sectional side view of the example unlockable tie 10. One or more teeth 56 (two illustrated, but in no way limited thereto) extend into the opening 50 to engage with one or more of the strap teeth 28 (not illustrated in FIGS. 2A-B). As illustrated, the teeth 56 are located below an upper surface of the front wall 42 and the latch 52 of the locking head 40 but are in no way intended to be limited thereto. Rather, an upper tooth 56 could be aligned with an upper surface of the front wall 42 and latch 52 without departing from the current scope. Furthermore, the upper surface of the latch 52 is illustrated as being aligned with the upper surface of the front wall 42 but is not limited thereto. According to one embodiment, the upper surface of the latch 52 may be blow the remainder of the locking head 40 to, for example, prevent accidentally unlocking thereof.

The latch teeth 56 may be saw tooth shaped as illustrated where on side is flat and the other side is angled (but are in no way intended to be limited thereto). As previously noted, the configuration of the one or more teeth 56 and the teeth 28 enable the strap 20 to traverse the opening 50 in the first direction (a tightening direction) but not in the second direction (a release or removable direction). The receptacle(s) 54 (only one visible) extend into the latch 52. The receptacle(s) 54 are to receive a tool therein. When the tool is inserted, the tool can be rotated away from the opening 50 causing the latch 52 to pivot away from the opening 50. The latch 52 may located on a fulcrum 58 such that a pivot point 60 is provided that enables the latch 52 to pivot away from the opening 50. When the latch 52 pivots, the teeth 56 are moved away from the teeth 28 such that they are disengaged from the teeth 28 and allow movement of the strap 20 within the opening 50 in the second direction (loosening or removal). The teeth 56 may move upward and to the left as illustrated when the latch 52 is pivoted.

As illustrated, the opening of the receptacle(s) 54 are from the second end (top as illustrated) of the latch 52 and extend straight down within the latch 52. However, the configuration of the receptacle(s) 54 is in no way intended to be limited thereto. Rather, the opening of the receptacle(s) 54 could be from a side (left as illustrated) of the latch 52 and/or could extend within the latch 52 at an angle without departing from the current scope. Any configuration that provides the ability to utilize a tool to unlock the tie 10 by pivoting the latch 52 in order to disengage the teeth 56 from the teeth 28 would be within the current scope.

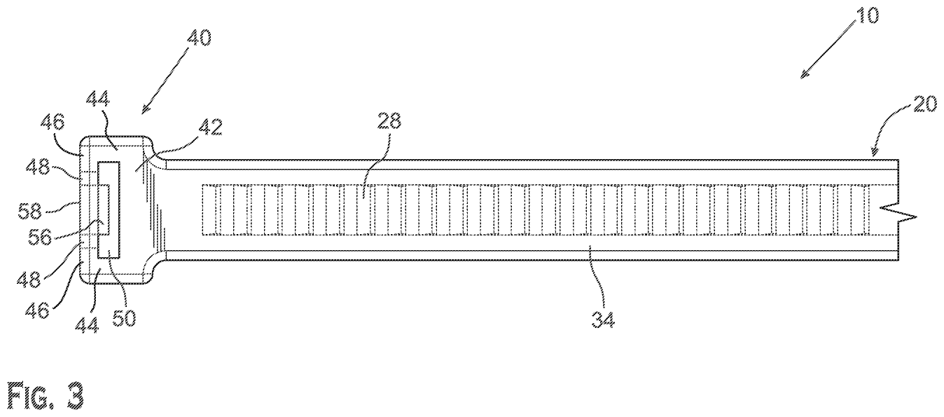

FIG. 3 illustrates a bottom view of the example unlockable tie 10 including the strap 20 and the locking head 40. A bottommost latch tooth 56 can be seen extending into the opening 50. The fulcrum 58 extends between the two partial back walls 46. The open portion 48 is located about the fulcrum 58 and the latch 52 is centrally located within the open portion 48. An underside 34 of the strap 10 may be smooth opposite the teeth 28 on the topside.

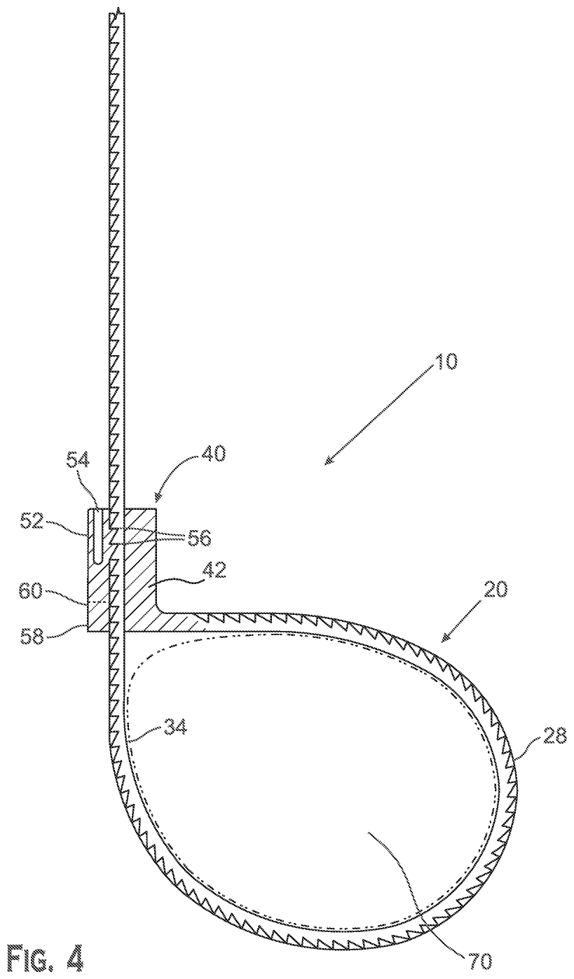

FIG. 4 illustrates a cross-sectional side view of the example unlockable tie 10 in a locked position. In the locked position the engagement of the latch teeth 56 and the strap teeth 28 within the opening 50 is clearly visible. When the strap 20 passes through the locking head 40 a loop 70 is formed for tightening around items (no items illustrated) to, for example, secure them together or secure them in place. The strap teeth 28 are located on an outside of the loop 70 and the bottom 34 of the strap 20 is located within the loop 70 and is in contact with items secured by the tie 10. As illustrated, the bottom 34 is smooth so that so there is no impact to the items when tightened. The latch 52 and the receptacle(s) 54 are located outside of the loop 70 and are not located between the strap 20 and the loop 70 to provide easy access to the receptacle(s) 50.

FIG. 5 illustrates a perspective view of an example tool 100 that can be utilized to unlock the unlockable cable tie 10. The tool 100 includes a main body 110 and a pair of pins 120 extending therefrom. The pair of pins 120 would be utilized to insert into two aligned receptacle(s) 54 in the example tie 10. The number, shape, orientation and size of the pins 120 may vary based on the number, shape, orientation and size of receptacles 54 in the example tie 10. The main body 110 is illustrated as generally rectangular but is not limited thereto.

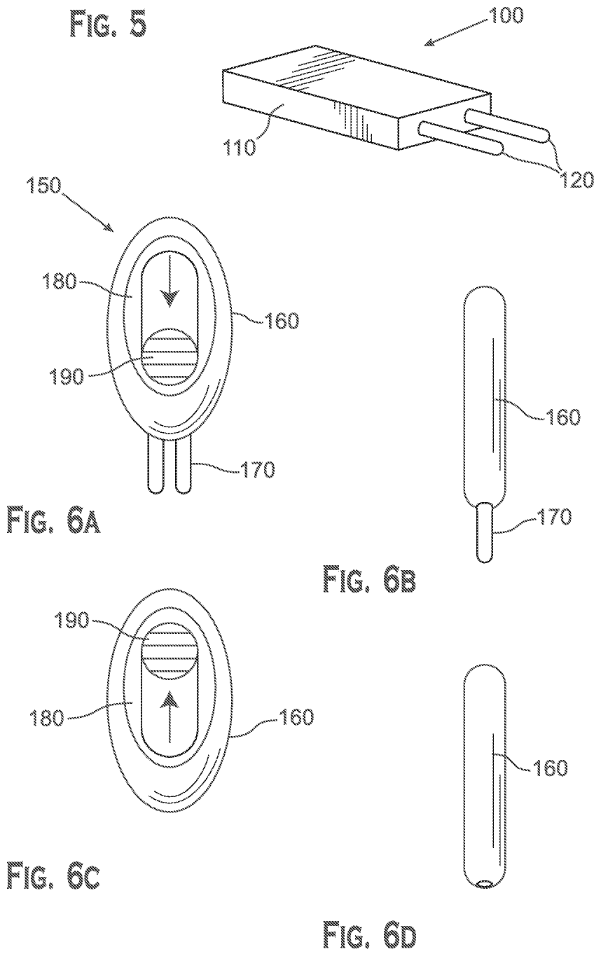

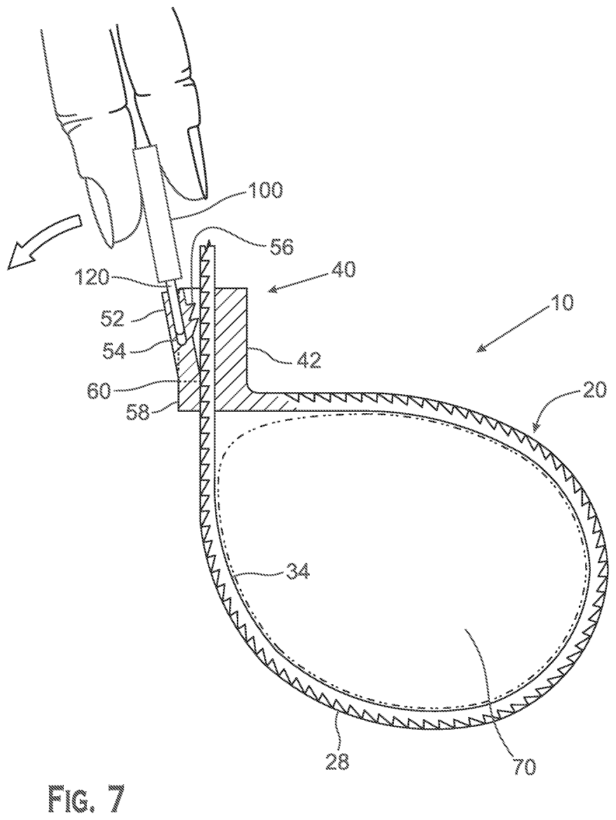

FIGS. 6A-D illustrate top and side views of an example tool 150 that can be utilized to unlock the unlockable cable tie 10. The tool 150 includes a main body 160 and pins (two illustrated) 170 extending therefrom. As illustrated, the main body 160 is oval shaped but is in no way intended to be limited thereby. The number, shape, orientation and size of the pins 170 may vary based on the number, shape, orientation and size of the receptacles 54 in the example tie 10. The pins 170 may be retractable such that they are housed within the main body 160 when the tool 150 is not and use and may be extended out of the main body 160 for use. FIGS. 6A-B illustrate the pins 170 extending from the housing 160 and FIGS. 6C-D illustrate the pins 170 retracted within the housing 160.

The main body 160 may include an activator 180 (e.g., switch, tab) capable of moving laterally that can retract and extend the pins 170. The activator 180 may be connected to the pins 170 so that when it is moved in a first direction (up or forward as illustrated) the pins 170 extend out of the housing 160 and when it is moved in a second direction (down or backward as illustrated) the pins 170 are retracted into the housing 160. The activator 180 may include a pad (e.g., thumb pad, finger pad) 190 to provide an area to utilize to move the activator 180. The manner in which the pins 170 are extended or retracted is not limited to an activator 180 located on a surface of the housing 160 as illustrated. Rather various means of causing the pins 170 to be extended and retracted could be utilized without departing the current scope.

FIG. 7 illustrates a cross-sectional side view of an example tool 100 being utilized to unlock an example unlockable tie 10. The pins 120 (only one visible) of the tool 100 are placed in the receptacles 54 (only one visible) of the latch 52 and then the tool 100 is pivoted away from the locking head 40 and strap 20 (to the left and downward as illustrated). The pivoting of the tool 100 causes latch 52 to pivot around the pivot point 60. The pivoting of the latch 52 causes the latch teeth 56 to become disengaged from the strap teeth 28. Once the latch teeth 56 and the strap teeth 28 are disengaged, the strap 20 can be moved within the locking head 40 in a release direction (to either loosen or remove the tie 10).

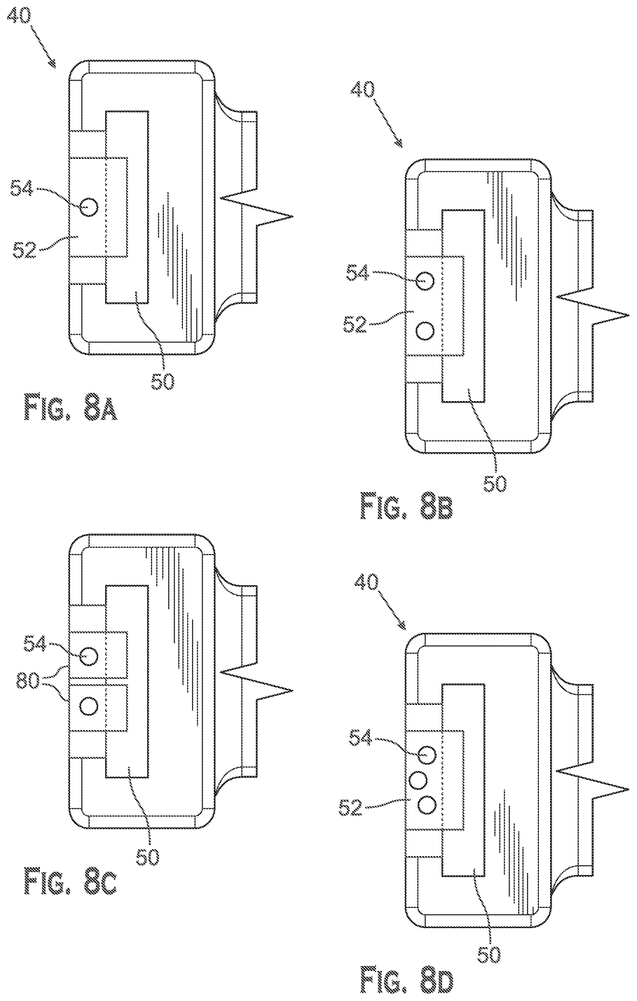

FIGS. 8A-D illustrate top views of various configurations of the receptacle(s) that could be formed in the latch 52 of the unlockable head 40 of an unlockable tie 10. FIG. 8A illustrates a single receptacle 54 formed in the latch 52. FIG. 8B illustrates a pair of aligned receptacles 54 (like those previously illustrated in FIG. 1B) formed in the latch 52. FIG. 8C illustrates a split latch 80 that is divided into two sides, where each side includes a single receptacle 54. Utilizing a split latch 80 ensures that the tool is received in both receptacles 54 in order to cause the latch 80 to pivot and disengage the latch teeth and strap teeth. While the split latch 80 is illustrated as two sides it is not limited thereto. FIG. 8D illustrates three receptacles 54 formed in the latch 52. The three receptacles 54 are illustrated as the outer two receptacles 54 (top and bottom as illustrated) being aligned (vertically as illustrated) with the center receptacle 54 being set back slightly (to the left as illustrated). The number, size, shape and orientation of the receptacles is not limited to those illustrated in FIGS. 8A-D.

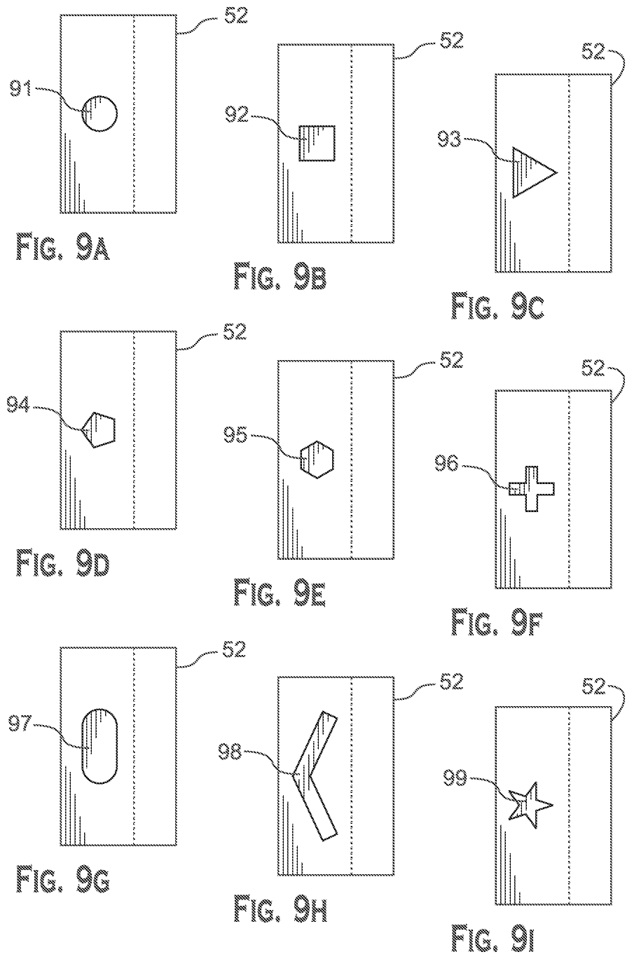

FIGS. 9A-I illustrate various shapes that could be utilized for the receptacles 54 on the latch 52. As illustrated only a single receptacle 54 is included but is in no way intended to be limited thereby. The shapes of the receptacles 54 could include, but are not limited to, circles 91, squares 92, triangles 93, pentagons 94, hexagons 95, plus signs 96, ovals 97, less than signs 98, and stars 99. If multiple receptacles 54 are included on the latch 52 they may be the same shape or may be different shapes.

According to one embodiment, the bottom 34 of the releasable tie 10 may be a surface that provides friction to prevent it from sliding off of items that it is securing. The friction surface may be formed in the bottom surface 34 when the tie 10 is created (e.g., molded). A friction material may be secured to a bottom surface 34 of the tie 10 in some fashion (e.g., glued, Velcro'ed ®, stitched). A friction surface may be formed in the bottom surface 34 after the tie 10 is created by, for example, machining.

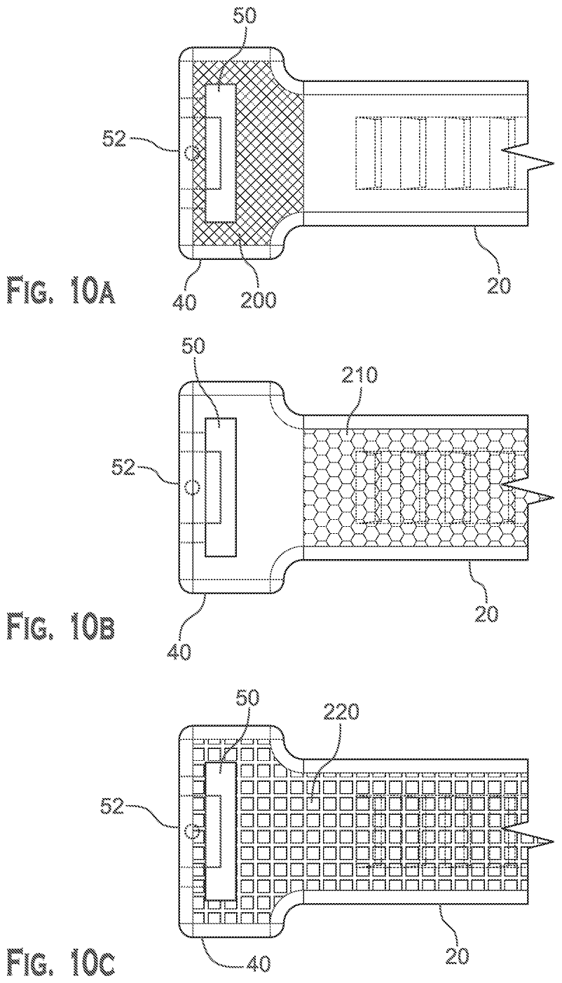

FIGS. 10A-C illustrate bottom views of several embodiments of example ties having a friction bottom surface. FIG. 10A illustrates an example tie where a friction surface 200 is located below the locking head 40. FIG. 10B illustrates an example tie where a friction surface 210 is located below the strap 20. FIG. 10C illustrates an example tie where a friction surface 220 is located below both the locking head 40 and the strap 20. The friction surfaces 200, 210, 220 are illustrated as cross-hatched, hexagons and squares for illustrative purposes and are in no was intended to be limited thereto.

The locking head 40 described in the various figures above do not include a solid rear wall but rather include includes the two partial back walls 46, the open portion 48 therebetween, the fulcrum 58 extending between the two partial back walls 46 and the latch 52 extending from the fulcrum 52 and centrally located within the open portion 48. As such an exterior wall of the locking head 40 is not fixed but is capable of pivoting. Such a structure may not have sufficient support to provide a tie 10 that can handle a large load (e.g., greater than 50 pounds). As such, additional support may be required. The support may be provided behind (further away from strap 20) the two partial back walls 46, the fulcrum 58 and the latch 52.

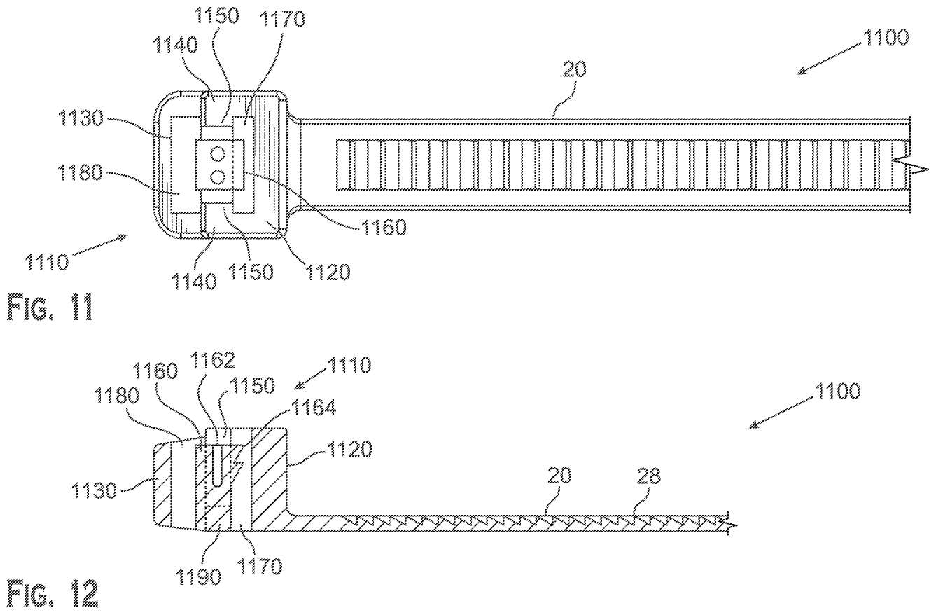

FIG. 11 illustrates a top view of an example unlockable tie 1100 having an unlockable locking head 1110 capable of supporting larger loads. The locking head 1110 includes a front wall 1120 abutting the strap 20, a back wall 1130 opposite the front wall 1120, sidewalls 1140 extending from opposite sides of the front wall 1120 to corresponding sides of the back wall 1130, centrally located walls 1150 extending from the sidewalls 1140 partially inward, a fulcrum (not visible) extending between the centrally located walls 1150, a latch 1160 extending from the fulcrum and located between the centrally located walls 1150, a first opening 1170 in front of (closer to the strap 20) the latch 1160, and a second opening 1180 behind (further away from strap 20) the latch 1160.

The opening 1170 is to allow the strap 20 to pass therethrough. The centrally located walls 1150 are to receive the guiderails 30 of the strap 20 and hold the strap 20 within the opening 1170. The latch 1160 extends into the opening 1170 and includes teeth (not visible) for engaging with the teeth in the strap 20. The latch 1160 allows the strap 20 to pass through the opening 1170 in a first direction (e.g., tightening) but not pass throw in a second direction (e.g., loosening, removing). The opening 1180 provides room for the latch 1160 to be pivoted away from the opening 1170 to disengage the teeth on the latch from the strap teeth and enable the strap 20 to be moved in the second direction. The latch 1160 includes receptacles 1162 to receive a tool to enable the latch 1160 to be pivoted away from opening 1170 into opening 1180.

FIG. 12 illustrates a cross sectional side view of an example unlockable tie 1100 having an unlockable locking head 1110 capable of supporting larger loads. The locking head 1110 includes an opening 1170 between the front wall 1120 and the latch 1160 for receiving the strap 20. The opening 1180 is located between the latch 1160 and the rear wall 1130 to enable the latch 1160 to be pivoted thereinto and out of the opening 1170. The latch 1160 extends upward from the fulcrum 1190 and includes teeth 1164 extending into the opening 1170 for engaging with the strap teeth 28. The latch 1160 also includes a receptacle 1162 for receiving a tool in order to pivot the latch 1160.

As illustrated, the height of the latch 1160 is below the height of the front wall 1120, sidewalls 1140 and the centrally located walls 1150. Providing the latch 1160 below in this fashion may reduce the possibly of the locking head 1110 accidentally being unlocked. However, the height is not limited to being lower than the height of the walls 1120, 1140, 1150. The height of the rear wall 1130 is also illustrated as being below the height of the walls 1120, 1140, 1150 but is not limited thereto.

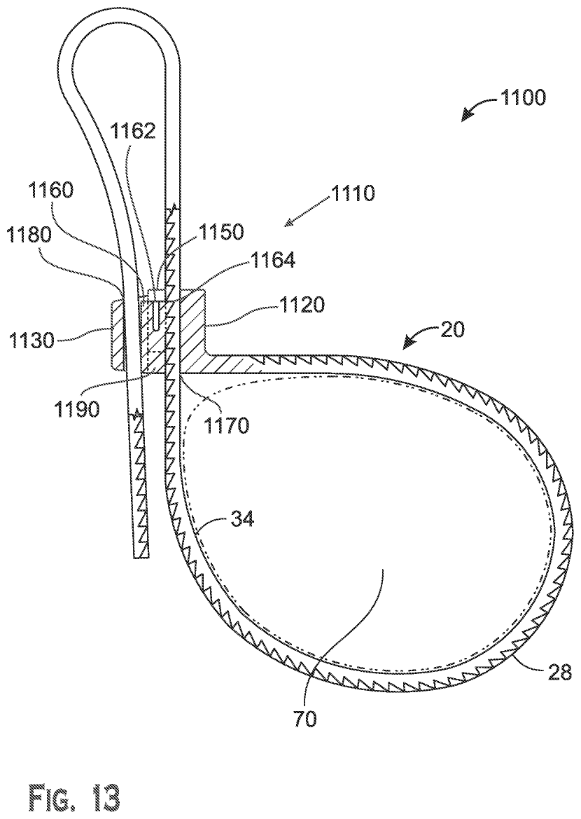

According to one embodiment, the opening 1180 may enable excess strap 20 (portion of strap 20 that passed through the locking head 1110) to be secured therein. FIG. 13 illustrates a cross sectional side view of the strap 20 of the example unlockable tie 1100 being looped back and tucked in the opening 1180. This arrangement may provide a barrier to the accidental unlocking of the tie 1100.

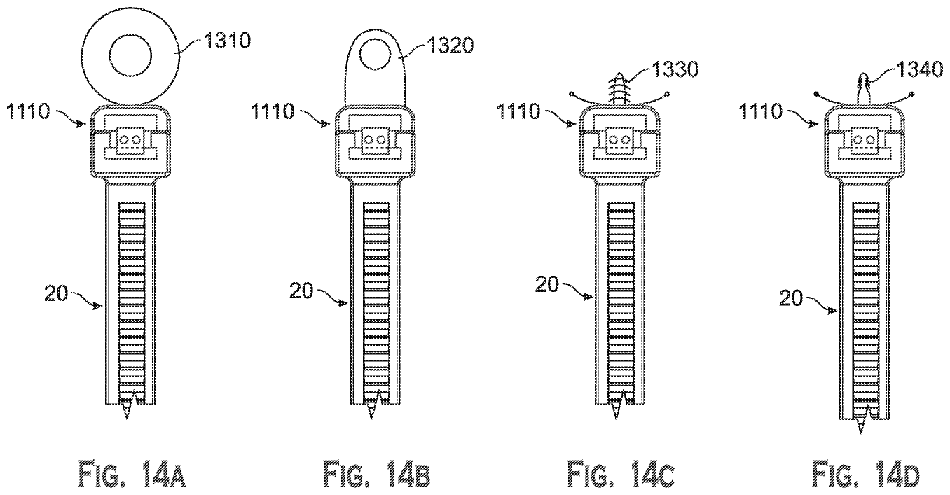

FIGS. 14A-F illustrate top views of example unlockable tie 1100 with connection mechanisms added thereto. The connection mechanism may enable the tie 1100 and any contents secured therein to be secured to an object (e.g., wall, ceiling, chassis, cabinet, desk). The connection mechanism may be secured to the locking head 1110. The connection mechanisms may be a body (e.g., tab, eyelet or the like) extending from the locking head 1110 having a hole(s) formed therein that enable the tie to be connected to an object with a screw, nail, rivet or the like or to be connected to a hook or the like mounted to the object. Alternatively, the connection mechanism may be a protrusion (e.g., screw, pin, rivet or the like) extending therefrom that may be used to mount to an object.

FIG. 14A illustrates a top view of an example unlockable tie that includes an eye loop 1310 extending from the locking head 1110 (specifically from the rear wall 1130 not separately identified). The eye loop 1310 may be used to receive a screw, nail, rivet or the like therethrough to secure the tie to an object (e.g., chassis). Alternatively, the eye loop 1310 may be utilized to secure around a hook, tab, pin or the like that is extending from an object that the tie is to be secured to. FIG. 14B illustrates a top view of an example unlockable tie that includes a mounted head 1320 extending from the locking head 1110. The mounted head 1320 includes a hole formed therethrough to enable a screw or the like to secure the tie to an object or to place around a hook or the like that is extending from an object that the tie is to be secured to.

FIG. 14C illustrates a top view of an example unlockable tie that includes a screw mount 1330 extending from the locking head 1110. The screw mount 1330 can be utilized to secure the tie to an object (e.g., chassis) by screwing the screw mount 1330 into a threaded hole formed in the object. FIG. 14D illustrates a top view of an example unlockable tie that includes a pin push mount 1340 extending from the locking head 1110. The pin push mount 1340 may include flanges (not numbered at an end thereof). The pin push mount 1340 can be utilized to secure the tie to an object (e.g., chassis) by pushing the push mount 1340 through a hole formed in the object where the flanges secure the tie within the hole.

FIG. 14E illustrates example top view of an example unlockable tie that include a label 1350 extending from the from the locking head 1110. The label 1350 may be used to identify the items that are secure therein. FIG. 14F illustrates a top view of an example unlockable tie that includes a handle 1380 extending from the from the locking head 1110. The handle 1380 may be used for carrying items that have been bundled together. For example, the handle 180 could be utilized to carry a power cord that has been wrapped and secured together with the tie.

FIGS. 1-14 focused on an embodiment where the latches 52, 1160 were on a far end (end away from the strap 20) of the locking heads 40, 1110. In this embodiment, the strap teeth 28 are located away from the items that are secured within the ties 10, 1100 (external to the loop 70). However, the ties 10, 1100 are not limited thereto. Rather, a tie could be configured such that a latch was on a near end (end connecting to the strap 20) of the locking head. In such an embodiment, the strap teeth 28 are located against the items that are secured with the tie (internal to the loop 70).

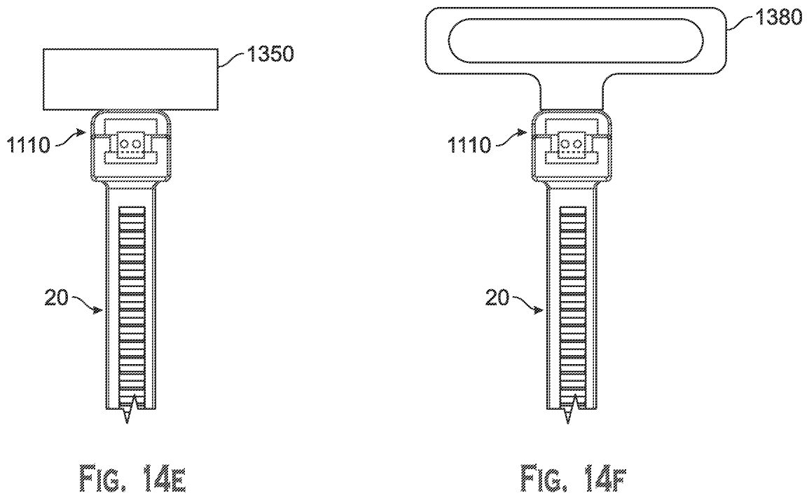

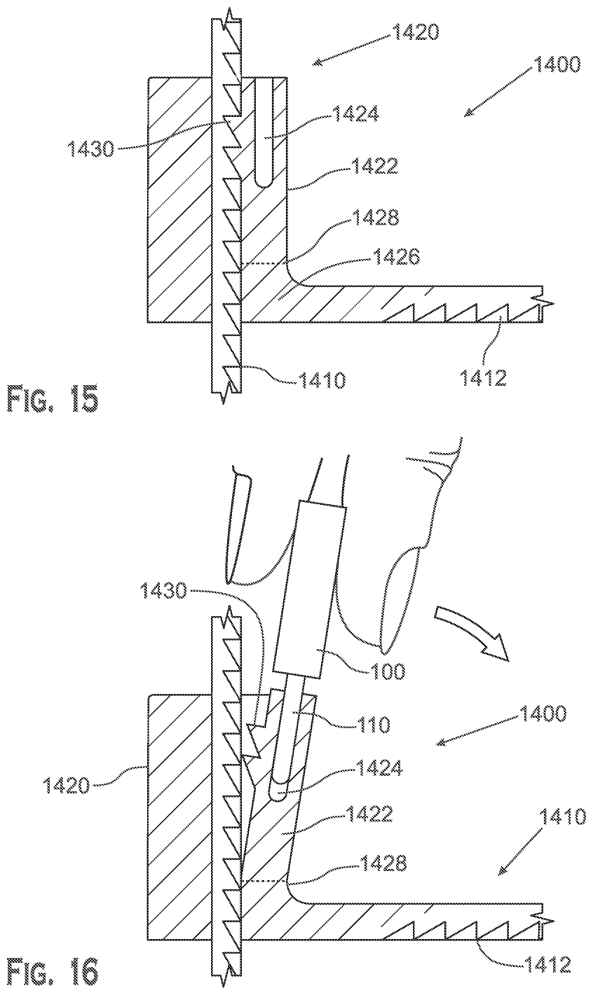

FIG. 15 illustrates a cross sectional side view of an example tie 1400 showing engagement of a strap 1410 and locking head 1420. The strap 1410 includes teeth 1412 on a lower side as illustrated so that the teeth 1412 face the strap 1410 when they pass through the opening in the locking head 1420. The locking head 220 includes a latch 1422 on a near end (end connecting to the strap 1410) thereof. The latch 1422 includes teeth 1430 that face the far end of the locking head 1420. The latch 1422 includes receptacle(s) 1424 on an upper side thereof for receiving a tool. The latch 1422 sits on a fulcrum 1426 in order to provide a pivot point 1428 therefore. As the latch 1422 pivots toward the strap 1410 the amount of pivoting is limited.

FIG. 16 illustrates a cross-sectional side view of an example tool 100 being utilized to unlock an example unlockable tie 1400. The pins 110 (only one visible) of the tool 100 are placed in the receptacles 1424 (only one visible) of the latch 1422 and then the tool 100 is pivoted away from the locking head 1420 and toward the strap 1410 (to the right and downward as illustrated). The pivoting of the tool 100 causes latch 1422 to pivot around the pivot point 1428. The pivoting of the latch 1422 causes the latch teeth 1430 to become disengaged from the strap teeth 1412. Once the latch teeth 1430 and the strap teeth 1412 are disengaged, the strap 1410 can be moved within the locking head 1420 in a release direction (to either loosen or remove the tie 1400).

According to one embodiment, various connection mechanisms, such as those illustrated in FIGS. 14A-F, could be added to the tie 1400. The connection mechanisms could be connected to a far side (side away from strap 1410) of the locking head 1420.

As the latch 1422 pivots toward the strap 1410 the amount of pivoting is limited. Alternative embodiments may be utilized to increase the amount of pivoting that can be obtained to ensure the pivoting results is disengagement of the latch teeth 1430 and the strap teeth 1412 so the strap 1410 can be moved within the locking head 1420 in the release direction.

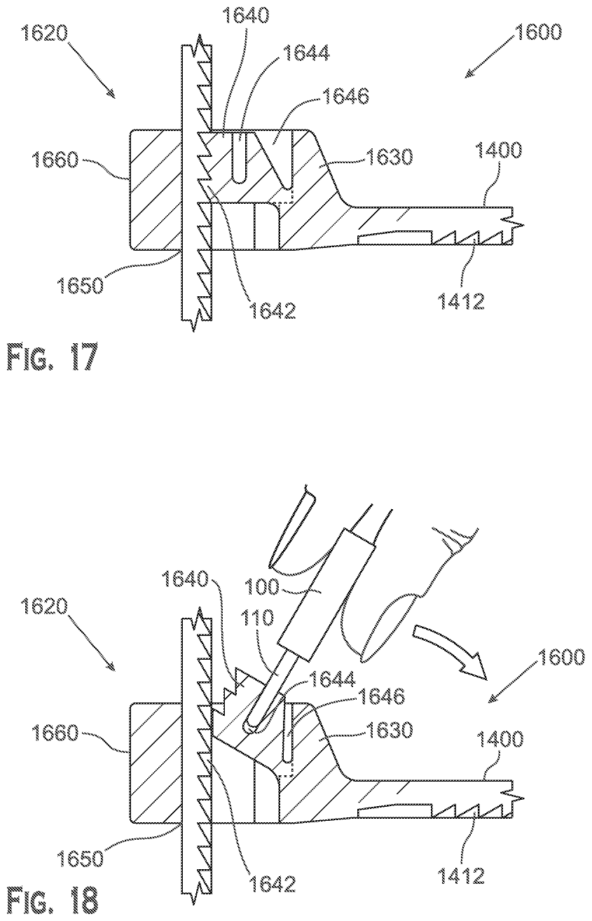

FIG. 17 illustrates a cross sectional side view of an example tie 1600 showing engagement of a strap 1410 and locking head 1620. The locking head 1620 includes a front wall 1630 abutting the strap 1410, a latch 1640 extending from the front wall 1630, an opening 1650 for allowing the strap 1410 to pass therethrough, and a rear wall 1160. The latch 1640 includes teeth 1642 that enter the opening 1650. The latch 1640 includes receptacle(s) 1644 on an upper side thereof for receiving a tool. The latch 1640 has an angled portion 1646 facing the front wall 1630 to enable the latch 1640 to pivot.

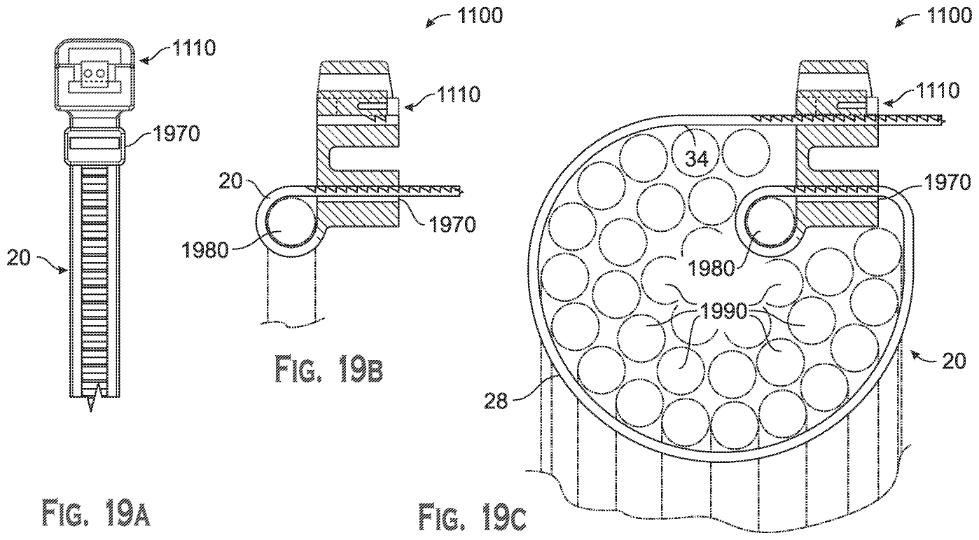

FIG. 18 illustrates a cross-sectional side view of an example tool 100 being utilized to unlock an example unlockable tie 1600. The pins 110 (only one visible) of the tool 100 are placed in the receptacles 1644 (only one visible) of the latch 1640 and then the tool 100 is pivoted toward the front wall 1630 of the locking head 1600 and the strap 1410 (to the right and downward as illustrated). The pivoting of the tool 100 causes latch 1640 to pivot which causes the latch teeth 1642 to become disengaged from the strap teeth 1412. Once the latch teeth 1642 and the strap teeth 1412 are disengaged, the strap 14100 can be moved within the locking head 1620 in a release direction (to either loosen or remove the tie 1600).

According to one embodiment, various connection mechanisms, such as those illustrated in FIGS. 14A-F, could be added to the tie 1600. The connection mechanisms could be connected to the rear wall 1160 of the locking head 1620.

FIG. 19A illustrates a top view of an example unlockable tie 1100 that includes a passthrough 1970 formed on a portion of the strap 20 prior to the locking head 1110. The passthrough 1970 may enable the strap 20 to pass therethrough to, for example, secure the tie to an item it is to be utilized with before the apparatus is tightened in use. For example, the tie may be secured to an end of a power cord by passing the strap 20 through the passthrough 1970 so that the tie is located on the power cord when the power cord is in use and is already in place when the power cord is wrapped for storage. By way of another example, the tie may be secured to an item (e.g., chassis, desk) that will have a plurality of cables traversing thereby. Once the cables are run the tie can be used to secure the cables in an organized fashion to the item.

FIG. 19B illustrates a cross sectional side view of an example unlockable tie 1100 wrapped around an item 1980 using the passthrough 1970 prior to the tie being used to unlockably secure the item to itself or to other items. For example, the item 1980 may be a power cord where the tie is secured thereto before the power cord is wrapped and secured together by passing the strap 20 through locking head 1110. The item 1980 may be a portion of a chassis or desk so that the tie is secured in place and then can be utilized once other items (e.g., cables, cords) are run and are to be secured releasable tie. FIG. 19C illustrates a cross sectional side view of an example unlockable tie 1100 wrapped around an item 1980 by passing the strap 20 through the passthrough 1970 and then around other items 1990 by passing the strap 20 through the locking head 1110. It should be noted that the item 1980 may be the same as the items 1990 (for example both may be a power cord) or may be different (for example, chassis and cables). The items 1990 may all be the same (for example one cord wrapped several times) or may be different items (for example different cables and/or cords run in a chassis).

It should be noted that the passthrough 1970 was illustrated as being implemented on the example unlockable tie 1100 but is not limited thereto. Rather, the passthrough 1970 could be implemented on any embodiment of an unlockable tie including the other example unlockable ties 10, 1400, 1600 described herein.

The example unlockable ties 10, 1100, 1400, 1600 preferably are molded in one piece integrally from thermoplastic, such as nylon or polypropylene and possesses sufficient strength and resiliency to permit the desired working thereof as well as the desired latching and release.

While the example unlockable tie has been described with respect to securing cables together and/or to items that the cables traverse the unlockable ties are in no way intended to be limited thereto. Rather the unlockable ties can be utilized to secure and types of items together or to other items without departing from the current scope.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

The invention claimed is:

1. An unlockable tightening apparatus, comprising:
an elongated planar strap having a plurality of strap teeth formed on one side thereof; and
an unlockable locking head formed adjacent to a first end of the strap, wherein the locking head includes
an opening to receive a second end of the strap in a locking direction to form a loop to secure around one or more items, wherein amount of the strap that traverses the opening controls size of the loop;
a latch including at least one lock tooth extending into the opening, wherein the at least one lock tooth is complementary to the strap teeth and adapted to engage with at least one strap tooth for preventing movement of the strap in a release direction; and
a receptacle within the latch to receive a tool, wherein the tool is to pivot the latch away from the opening to release the at least one lock tooth from engagement with the at least one strap tooth to permit the strap to be moved in the release direction.

2. The apparatus of claim 1, wherein the one or more items include cables.

3. The apparatus of claim 1, wherein the one or more items include cables and a structure with which the cables are secured to.

4. The apparatus of claim 1, wherein the receptacle extends vertically within a portion of the latch external to the opening.

5. The apparatus of claim 1, wherein the receptacle includes a plurality of receptacles.

6. The apparatus of claim 1, wherein the strap teeth are configured to be external to the loop.

7. The apparatus of claim 6, wherein the locking head includes
a front wall abutting the strap;
two sidewalls extending perpendicularly from the front wall;
two partial walls extending inward from the sidewalls but providing an open portion therebetween; and
a fulcrum extending between the two partial sidewalls, wherein the latch extends from the fulcrum and is centrally located between the open portion.

8. The apparatus of claim 7, wherein the locking head further includes
a rear wall extending between the two sidewalls; and
a gap between the rear wall and the latch to provide room for the latch to pivot.

9. The apparatus of claim 1, wherein the strap teeth are configured to be internal to the loop.

10. The apparatus of claim 9, wherein
the locking head includes a wall abutting the strap;
the latch includes a sloped side opposite the at least one lock tooth;
a lower portion of the sloped side is connected to wall; and
a gap is created between the sloped side and the wall, and the gap provides the ability to pivot the latch away from the opening.

11. A method of providing an unlockable tightening connection around one or more items, the method comprising:
providing an elongate planar strap having a plurality of strap teeth formed on one side and a locking head formed on one end;
securing the strap around the one or more items when the one or more items are to be secured by
inserting an opposite end of the strap into an opening in the locking head in a locking direction and forming a loop to receive the one or more items, wherein amount of the strap that traverses the opening controls size of the loop; and
locking the strap in the locking head by engaging at least one lock tooth formed in a latch of the locking head complementary to the strap teeth and extending into the opening with at least one strap tooth to prevent movement of the strap in a release direction; and
releasing the strap from around the one or more items when the one or more items are to be released by
inserting a tool into a receptacle in the latch and pivoting the latch away from the opening to disengage the least one lock tooth from the at least one strap tooth; and
pulling a portion of the strap making up the loop in a direction away from the locking head.

12. The method of claim 11, wherein the securing the strap includes securing the strap around one or more cables.

13. The method of claim 11, wherein the securing the strap includes securing the strap around cables and a structure.

14. The method of claim 11, wherein the inserting the tool into the receptacle includes inserting a plurality of pins of the tool into a plurality of receptacles.

15. The method of claim 14, wherein the pivoting the latch away from the opening including pivoting the latch away from the strap.

16. The method of claim 11, wherein the inserting the opposite end of the strap into the opening includes inserting the strap so the strap teeth are internal to the loop.

17. The method of claim 16, wherein the pivoting the latch away from the opening including pivoting the latch toward the strap.

18. An unlockable tightening apparatus, comprising:
an elongated planar strap having a plurality of strap teeth formed on one side thereof; and
an unlockable locking head formed adjacent to a first end of the strap, wherein the locking head includes
a front wall abutting the strap;
two sidewalls extending perpendicularly from the front wall;
two partial walls extending inward from the sidewalls but providing an open portion therebetween;
a fulcrum extending between the two partial sidewalls;
an opening to receive a second end of the strap in a locking direction;
a latch mounted on the fulcrum and located between the open portion, wherein the latch includes at least one lock tooth extending into the opening, wherein the at least one lock tooth is complementary to the strap teeth and adapted to engage with at least one strap tooth to preventing movement of the strap in a release direction; and
a receptacle within the latch to receive a tool, wherein the tool is to pivot the latch away from the opening to release the at least one lock tooth from engagement with the at least one strap tooth to permit the strap to be moved in the release direction.

19. The apparatus of claim 18, wherein the locking head further includes
a rear wall extending between the two sidewalls; and
a gap between the rear wall and the latch to provide room for the latch to pivot.

20. The apparatus of claim 18, wherein the strap includes guide rails extending along each edge and surrounding the strap teeth, wherein the two partial walls are to receive the guiderails and hold the strap within the opening.
